(19) United States
(12) Patent Application Publication
(10) Pub. No.: US 2022/0277169 A1
(43) Pub. Date: Sep. 1, 2022

(54) SYSTEMS AND METHODS INCLUDING A MACHINE-LEARNT MODEL FOR RETRIEVAL

(71) Applicant: Walmart Apollo, LLC, Bentonville, AR (US)

(72) Inventors: Tony Elio Lee, Palo Alto, CA (US); Juexin Lin, Redwood City, CA (US); Kaihao Li, Sunnyvale, CA (US); Satya Chembolu, Santa Clara, CA (US); Lakshmi Thyagarajan, Los Altos, CA (US)

(21) Appl. No.: 17/187,464

(22) Filed: Feb. 26, 2021

(51) Int. Cl. G06K 9/62; G06K 9/68; G06N 20/00

(52) U.S. Cl. CPC G06K 9/623; G06K 9/6259; G06K 9/68; G06N 20/00; G06F 13/4221

(57) ABSTRACT

Systems and methods for retrieving a set of items are disclosed. A target string is received and a set of candidate items is selected from a pool of items based on the target string. The set of candidate items is ranked based on a scoring function. The scoring function includes a plurality of simultaneously determined coefficients. The plurality of simultaneously determined coefficients are generated by a trained ranking model. A set of N items selected from the set of candidate items based on the ranking is output.

### TECHNICAL FIELD

This application relates generally to data retrieval and, more particularly, to machine-learnt retrieval using tunable factors.

### BACKGROUND

Computer-implemented retrieval of relevant items from an index relies on a scoring function to calculate a retrieval score. Current systems utilize scoring functions having fixed coefficients and fixed balances for considering multiple inputs. For example, in an e-commerce environment, a scoring function may include coefficients configured to combine multiple product parameters, such as brand, product type, size, product category, etc. The potential pool of items can be in the millions. After selecting a set of N items, systems may implement additional mechanisms (e.g., second phase ranking) to select a subset of the retrieved items.

Current systems, which use fixed coefficients pre-calculated for specific product parameters, require individual and manual tuning of the coefficients when the scoring function is generated. Manually tuned coefficients provide suboptimal search results and are difficult to balance. The addition of new parameters requires calculation of new coefficients and manual balancing of the existing coefficients against the new coefficients, a tedious and time consuming process.

### SUMMARY

In various embodiments, a system is disclosed. The system includes a non-transitory memory having instructions stored thereon and a processor configured to read the instructions. The processor is configured to read the instructions to receive a target string and obtain a set of candidate items from a pool of items based on the target string. The processor is further configured to rank the set of candidate items based on a scoring function. The scoring function includes a plurality of simultaneously determined coefficients are generated by a trained ranking model. The processor is further configured to output a set of N items selected from the set of candidate items based on the ranking.

In various embodiments, a non-transitory computer readable medium having instructions stored thereon is disclosed. The instructions, when executed by a processor cause a device to perform operations including receiving a target string, obtaining a set of candidate items based on the target string, ranking the set of candidate items based on a scoring function, and outputting a set of N items selected from the set of candidate items based on the ranking. The scoring function includes a plurality of simultaneously determined coefficients generated by a trained ranking model. The scoring function is:

$$score = {\sum }_{i = 1}^{n} {c}_{i} * {P}_{i}$$

where Pᵢ is an i^{th} feature of a candidate item in the set of candidate items, cᵢ is a coefficient corresponding to the i^{th} feature selected from the plurality of simultaneously determined coefficients, and n is the total number of features for the candidate item.

In various embodiments, a computer-implemented method is disclosed. The computer-implemented method includes the steps of receiving a target string, obtaining a set of candidate items based on the target string, ranking the set of candidate items based on a scoring function, and outputting a set of N items selected from the set of candidate items based on the ranking. The scoring function includes a plurality of simultaneously determined coefficients generated by a trained ranking model trained using a set of combined relevance and engagement labels.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates a block diagram of a computer system, in accordance with some embodiments.

FIG. 2 illustrates a network environment configured to provide item ranking and retrieval using a ranking model, in accordance with some embodiments.

FIG. 3 is a flowchart illustrating a method of ranking and retrieving items, in accordance with some embodiments.

FIG. 4 is a process flow illustrating various steps of the method of ranking and retrieving items, in accordance with some embodiments.

FIG. 5 is a flowchart illustrating a method of training a ranking model, in accordance with some embodiments.

FIG. 6 is a process flow illustrating various steps of the method of training a ranking model of FIG. 5, in accordance with some embodiments.

FIG. 7 illustrates a method of selecting a set of coefficients having an optimized weighting value w, in accordance with some embodiments.

### DETAILED DESCRIPTION

The description of the preferred embodiments is intended to be read in connection with the accompanying drawings, which are to be considered part of the entire written description of this invention. The drawing figures are not necessarily to scale and certain features of the invention may be shown exaggerated in scale or in somewhat schematic form in the interest of clarity and conciseness. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In various embodiments, systems and methods of item ranking and retrieval used a trained ranking model are disclosed. The trained ranking model is generated from a scalable machine-learning framework configured to allow simultaneous tuning of a plurality of coefficients used to determine a ranking score. The trained ranking model can be configured to balance the relevance of search results against engagement objectives based on relevance and engagement score factors. The trained ranking model may be trained by a training set including past relevance data, engagement data, and/or other applicable retrieval data. The trained ranking model is configured to retrieve a set of candidate items from a pool of items based on the simultaneously tuned coefficients and a predetermined set of item parameters. In some embodiments, the trained ranking model can be reconfigured (e.g., retrained) to easily incorporate additional or new product parameters and coefficients.

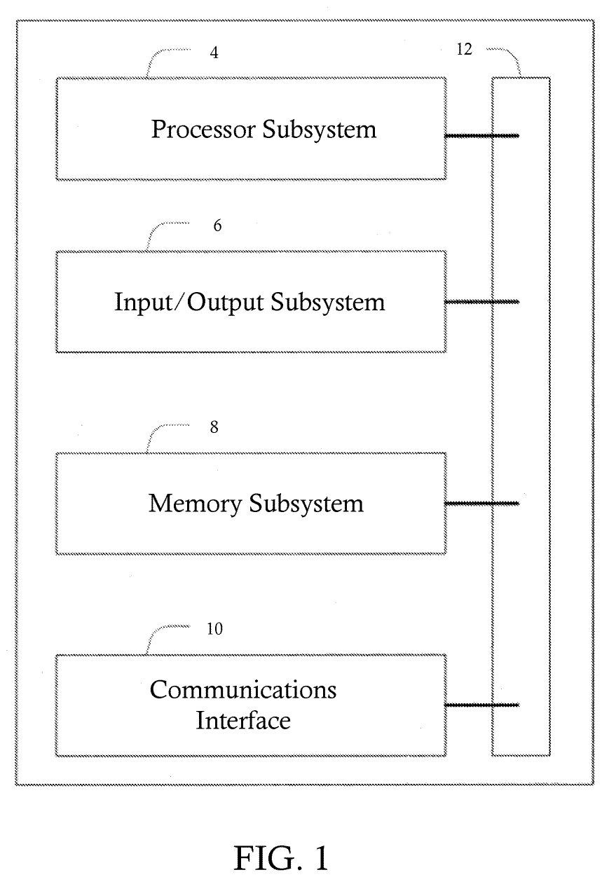

FIG. 1 illustrates a computer system configured to implement one or more processes, in accordance with some embodiments. The system 2 is a representative device and may comprise a processor subsystem 4, an input/output subsystem 6, a memory subsystem 8, a communications interface 10, and a system bus 12. In some embodiments, one or more than one of the system 2 components may be combined or omitted such as, for example, not including an input/output subsystem 6. In some embodiments, the system 2 may comprise other components not combined or comprised in those shown in FIG. 1. For example, the system 2 may also include, for example, a power subsystem. In other embodiments, the system 2 may include several instances of the components shown in FIG. 1. For example, the system 2 may include multiple memory subsystems 8. For the sake of conciseness and clarity, and not limitation, one of each of the components is shown in FIG. 1.

The processor subsystem 4 may include any processing circuitry operative to control the operations and performance of the system 2. In various aspects, the processor subsystem 4 may be implemented as a general purpose processor, a chip multiprocessor (CMP), a dedicated processor, an embedded processor, a digital signal processor (DSP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The processor subsystem 4 also may be implemented by a controller, a microcontroller, an application specific integrated circuit (ASIC), a field programmable gate array (FPGA), a programmable logic device (PLD), and so forth.

In various aspects, the processor subsystem 4 may be arranged to run an operating system (OS) and various applications. Examples of an OS comprise, for example, operating systems generally known under the trade name of Apple OS, Microsoft Windows OS, Android OS, Linux OS, and any other proprietary or open source OS. Examples of applications comprise, for example, network applications, local applications, data input/output applications, user interaction applications, etc.

In some embodiments, the system 2 may comprise a system bus 12 that couples various system components including the processing subsystem 4, the input/output subsystem 6, and the memory subsystem 8. The system bus 12 can be any of several types of bus structure(s) including a memory bus or memory controller, a peripheral bus or external bus, and/or a local bus using any variety of available bus architectures including, but not limited to, 9-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect Card International Association Bus (PCMCIA), Small Computers Interface (SCSI) or other proprietary bus, or any custom bus suitable for computing device applications.

In some embodiments, the input/output subsystem 6 may include any suitable mechanism or component to enable a user to provide input to system 2 and the system 2 to provide output to the user. For example, the input/output subsystem 6 may include any suitable input mechanism, including but not limited to, a button, keypad, keyboard, click wheel, touch screen, motion sensor, microphone, camera, etc.

In some embodiments, the input/output subsystem 6 may include a visual peripheral output device for providing a display visible to the user. For example, the visual peripheral output device may include a screen such as, for example, a Liquid Crystal Display (LCD) screen. As another example, the visual peripheral output device may include a movable display or projecting system for providing a display of content on a surface remote from the system 2. In some embodiments, the visual peripheral output device can include a coder/decoder, also known as Codecs, to convert digital media data into analog signals. For example, the visual peripheral output device may include video Codecs, audio Codecs, or any other suitable type of Codec.

The visual peripheral output device may include display drivers, circuitry for driving display drivers, or both. The visual peripheral output device may be operative to display content under the direction of the processor subsystem 6. For example, the visual peripheral output device may be able to play media playback information, application screens for application implemented on the system 2, information regarding ongoing communications operations, information regarding incoming communications requests, or device operation screens, to name only a few.

In some embodiments, the communications interface 10 may include any suitable hardware, software, or combination of hardware and software that is capable of coupling the system 2 to one or more networks and/or additional devices. The communications interface 10 may be arranged to operate with any suitable technique for controlling information signals using a desired set of communications protocols, services or operating procedures. The communications interface 10 may comprise the appropriate physical connectors to connect with a corresponding communications medium, whether wired or wireless.

Vehicles of communication comprise a network. In various aspects, the network may comprise local area networks (LAN) as well as wide area networks (WAN) including without limitation Internet, wired channels, wireless channels, communication devices including telephones, computers, wire, radio, optical or other electromagnetic channels, and combinations thereof, including other devices and/or components capable of/associated with communicating data. For example, the communication environments comprise in-body communications, various devices, and various modes of communications such as wireless communications, wired communications, and combinations of the same.

Wireless communication modes comprise any mode of communication between points (e.g., nodes) that utilize, at least in part, wireless technology including various protocols and combinations of protocols associated with wireless transmission, data, and devices. The points comprise, for example, wireless devices such as wireless headsets, audio and multimedia devices and equipment, such as audio players and multimedia players, telephones, including mobile telephones and cordless telephones, and computers and computer-related devices and components, such as printers, network-connected machinery, and/or any other suitable device or third-party device.

Wired communication modes comprise any mode of communication between points that utilize wired technology including various protocols and combinations of protocols associated with wired transmission, data, and devices. The points comprise, for example, devices such as audio and multimedia devices and equipment, such as audio players and multimedia players, telephones, including mobile telephones and cordless telephones, and computers and computer-related devices and components, such as printers, network-connected machinery, and/or any other suitable device or third-party device. In various implementations, the wired communication modules may communicate in accordance with a number of wired protocols. Examples of wired protocols may comprise Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, to name only a few examples.

Accordingly, in various aspects, the communications interface 10 may comprise one or more interfaces such as, for example, a wireless communications interface, a wired communications interface, a network interface, a transmit interface, a receive interface, a media interface, a system interface, a component interface, a switching interface, a chip interface, a controller, and so forth. When implemented by a wireless device or within wireless system, for example, the communications interface 10 may comprise a wireless interface comprising one or more antennas, transmitters, receivers, transceivers, amplifiers, filters, control logic, and so forth.

In various aspects, the communications interface 10 may provide data communications functionality in accordance with a number of protocols. Examples of protocols may comprise various wireless local area network (WLAN) protocols, including the Institute of Electrical and Electronics Engineers (IEEE) 802.xx series of protocols, such as IEEE 802.11a/b/g/n, IEEE 802.16, IEEE 802.20, and so forth. Other examples of wireless protocols may comprise various wireless wide area network (WWAN) protocols, such as GSM cellular radiotelephone system protocols with GPRS, CDMA cellular radiotelephone communication systems with 1× RTT, EDGE systems, EV-DO systems, EV-DV systems, HSDPA systems, and so forth. Further examples of wireless protocols may comprise wireless personal area network (PAN) protocols, such as an Infrared protocol, a protocol from the Bluetooth Special Interest Group (SIG) series of protocols (e.g., Bluetooth Specification versions 5.0, 6, 7, legacy Bluetooth protocols, etc.) as well as one or more Bluetooth Profiles, and so forth. Yet another example of wireless protocols may comprise near-field communication techniques and protocols, such as electro-magnetic induction (EMI) techniques. An example of EMI techniques may comprise passive or active radio-frequency identification (RFID) protocols and devices. Other suitable protocols may comprise Ultra Wide Band (UWB), Digital Office (DO), Digital Home, Trusted Platform Module (TPM), ZigBee, and so forth.

In some embodiments, at least one non-transitory computer-readable storage medium is provided having computer-executable instructions embodied thereon, wherein, when executed by at least one processor, the computer-executable instructions cause the at least one processor to perform embodiments of the methods described herein. This computer-readable storage medium can be embodied in memory subsystem 8.

In some embodiments, the memory subsystem 8 may comprise any machine-readable or computer-readable media capable of storing data, including both volatile/non-volatile memory and removable/non-removable memory. The memory subsystem 8 may comprise at least one non-volatile memory unit. The non-volatile memory unit is capable of storing one or more software programs. The software programs may contain, for example, applications, user data, device data, and/or configuration data, or combinations therefore, to name only a few. The software programs may contain instructions executable by the various components of the system 2.

In various aspects, the memory subsystem 8 may comprise any machine-readable or computer-readable media capable of storing data, including both volatile/non-volatile memory and removable/non-removable memory. For example, memory may comprise read-only memory (ROM), random-access memory (RAM), dynamic RAM (DRAM), Double-Data-Rate DRAM (DDR-RAM), synchronous DRAM (SDRAM), static RAM (SRAM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk memory (e.g., floppy disk, hard drive, optical disk, magnetic disk), or card (e.g., magnetic card, optical card), or any other type of media suitable for storing information.

In one embodiment, the memory subsystem 8 may contain an instruction set, in the form of a file for executing various methods, such as methods including A/B testing and cache optimization, as described herein. The instruction set may be stored in any acceptable form of machine readable instructions, including source code or various appropriate programming languages. Some examples of programming languages that may be used to store the instruction set comprise, but are not limited to: Java, C, C++, C#, Python, Objective-C, Visual Basic, or .NET programming. In some embodiments a compiler or interpreter is comprised to convert the instruction set into machine executable code for execution by the processing subsystem 4.

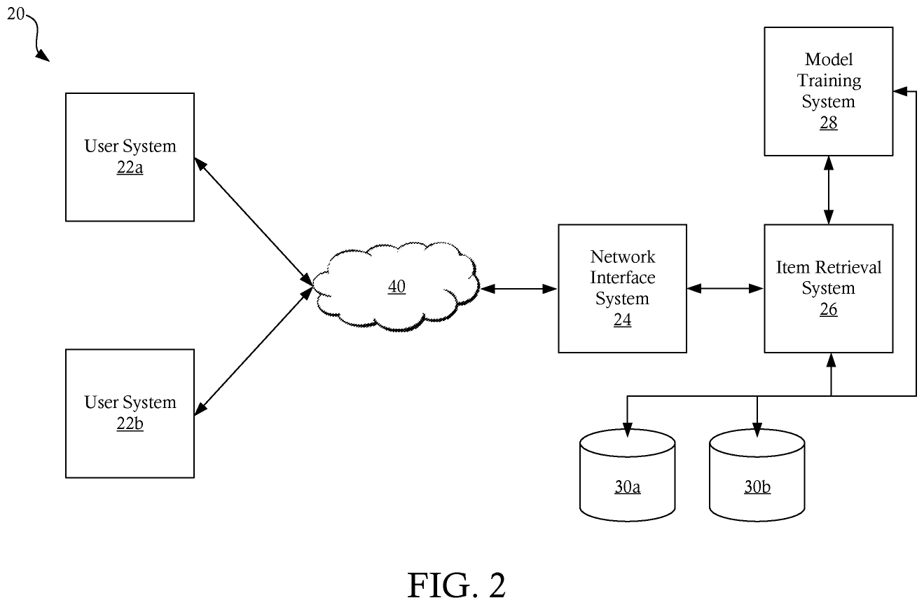

FIG. 2 illustrates a network environment 20 configured to provide item retrieval using a trained ranking model, in accordance with some embodiments. The network environment 20 may include, but is not limited to, one or more user systems 22a, 22b, a network interface system 24, an item retrieval system 26, a model training system 28, one or more item databases 30a, 30b, and/or any other suitable system. Each of the systems 22a-28 and/or the databases 30a-30b may include a system as described above with respect to FIG. 1. Although embodiments are illustrates herein having discrete systems, it will be appreciated that one or more of the illustrated systems may be combined into a single system configured to implement the functionality and/or services of each of the combined systems. For example, although embodiments are illustrated and discussed herein including each of a network interface system 24, an item retrieval system 26, and a model training system 28, it will be appreciated that these systems may be combined into a single logical and/or physical system configured to perform the functions and/or provide services associated with each of the individual systems. It will also be appreciated that each of the illustrated systems may be replicated and/or split into multiple systems configured to perform similar functions and/or parts of a function.

In some embodiments, the network interface system 24 is configured to provide a network interface to the one or more user systems 22a, 22b. The network interface may include any suitable type of network interface, such as, for example, an e-commerce interface, a search interface, an inventory interface, etc. Although embodiments are discussed herein with reference to an e-commerce network interface, it will be appreciated that the disclosed systems and methods are applicable to any interface including sets of items that may be retrieved based on search queries and rankings.

In some embodiments, the network interface 24 is configured to receive a target input from a user system 22a, 22b. The target input may include, for example, a search query, item name, category type, etc. The target input may include any suitable format, such as, for example, an alphanumeric string. In some embodiments, the target input includes an alphanumeric search string. For example, in an e-commerce environment, a user system 22a, 22b may provide a search string to the network interface system 24. Although embodiments are discussed herein including a target alphanumeric search string, it will be appreciated that the disclosed systems and methods may be applied to any system using a target string input to identify items in a set of items.

In some embodiments, the network interface system 24 is in signal (e.g., data) communication with an item retrieval system 26. The item retrieval system 26 is configured to retrieve a set of candidate items based on the received target input. For example, in some embodiments, the item retrieval system 26 utilizes a trained ranking model to identify a set of candidate items from a pool of potential items. As discussed in greater detail below, in some embodiments, the identification of candidate items is based on a ranking score calculated by a trained ranking model using a plurality of simultaneously tuned coefficients.

In some embodiments, the item retrieval system 26 is in signal (e.g., data) communication with one or more item databases 30a, 30b containing representations of the pool of items for each item in the pool of items. In some embodiments, the item retrieval system 26 is configured calculate ranking scores for each item in the pool item based on a received target query. The item retrieval system 26 may be configured to load only a portion of the representations in the item database(s) 30a, 30b. For example, in some embodiments, representations in the item database 30a, 30b may be sorted by predefined categories, geographic areas, etc. and the comparison process may use only one or more of the predefined categories.

In some embodiments, the item retrieval system is in signal (e.g., data) communication with a model training system 28. The model training system 28 may be configured to generate a trained ranking model by training an untrained or previously trained ranking model using training data. For example, in some embodiments, the model training system 28 is configured to generate a trained ranking model using a machine learning algorithm and/or untrained model, such as a list-wise loss model (e.g., ListNet), a linear regression model, RankNet, etc. It will be appreciated that the specific machine learning algorithm used may be any suitable machine learning algorithm.

In some embodiments, the model training system 28 is configured to generate a trained ranking model and provide the trained ranking model to the item retrieval system 26 for use in item ranking and retrieval. In other embodiments, the trained ranking model may be implemented directly on the model training system 28 and/or any other system and accessed by the item retrieval system 26 using one or more network connections. It will be appreciated that any suitable network or system architecture may be used to implement the disclosed systems and methods.

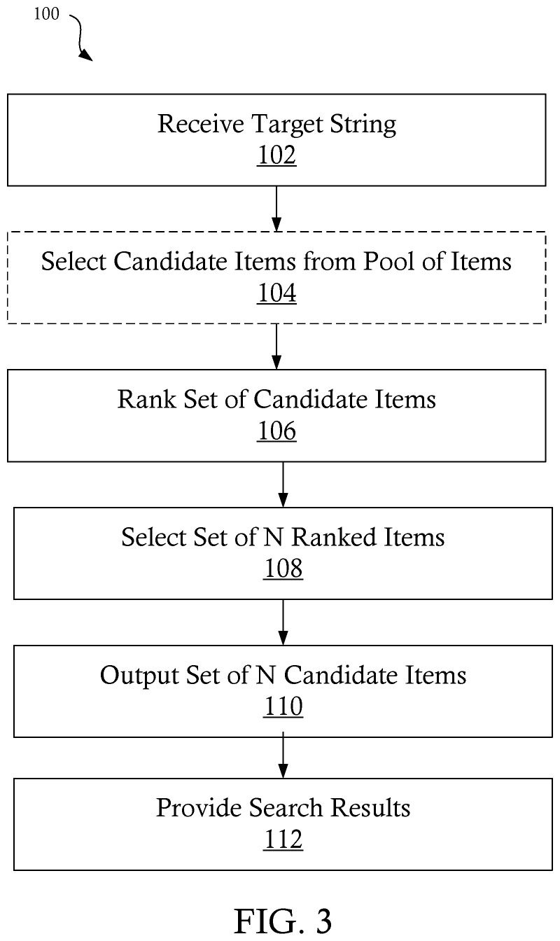

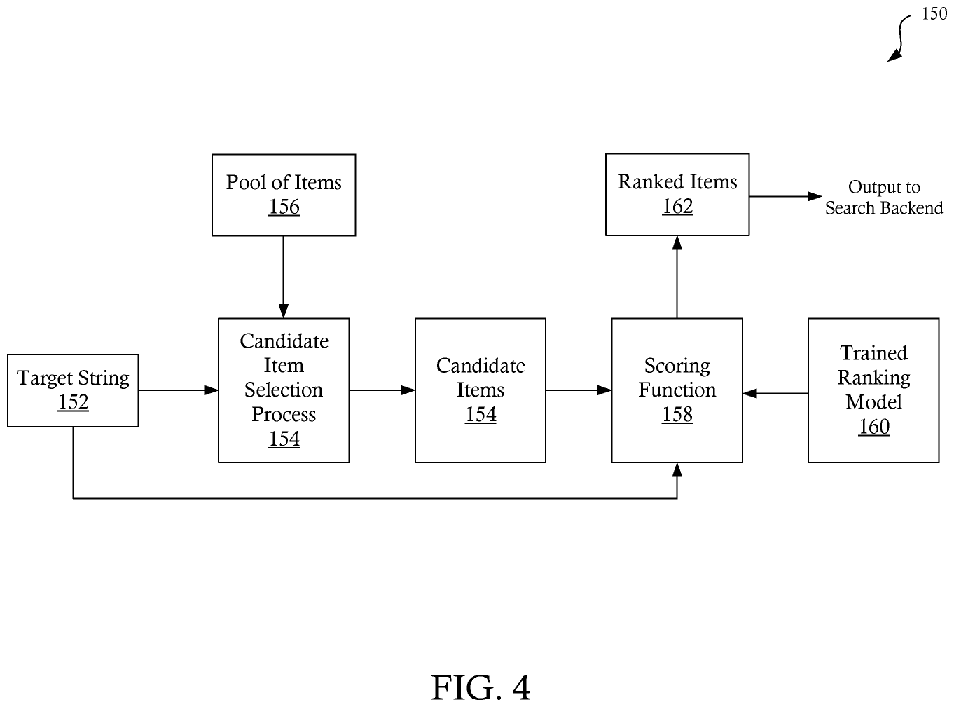

FIG. 3 is a flowchart illustrating a method 100 of selecting content from a predetermined pool using a trained ranking model, in accordance with some embodiments. FIG. 4 is a process flow 150 illustrating various steps of the method 100 of selecting content from a predetermined pool using a trained ranking model illustrated in FIG. 3, in accordance with some embodiments. At step 102, a target string 152 is received. The target string may be received from any suitable system, such as, for example, a user system 22a, 22b. In some embodiments, the target string includes an alphanumeric string. The target string may include any suitable string, such as, for example, a search query, an item identifier, a stock-keeping unit (SKU), and/or any other suitable alphanumeric string.

At step 104, a set of candidate items 154 is selected from a pool of items 156 using a candidate item selection process 155. In some embodiments, the set of candidate items 154 are selected based on, for example, a text comparison between the target string and the items in the pool of items. It will be appreciated that any suitable search algorithm or process may be used to select the set of candidate items 154 from the pool of items 156. The pool of items 156 may be stored in a database, such as one or more of the databases 30a-30b discussed above. The initial search and selection of the set of candidate items is performed by an item ranking model 158 and/or by a search engine or other query system. In some embodiments, step 104 is skipped and the set of candidate items 154 is the same as the pool of items 156.

At step 106, the target string 152 and the set of candidate items 154 are used to rank the set of candidate items. For example, in some embodiments, a scoring function 158 including a set of simultaneously tuned coefficients is configured to rank the set of candidate items 154. Each of the simultaneously tuned coefficients are applied to an item parameter associated with each of the items in the pool of items. As a non-limiting example, the item parameters may include a text score parameter generated based on a comparison between an alphanumeric search string and text associated with an item, an item popularity parameter, a product type match parameter, a brand match parameter, size match parameter, a color match parameter, a quantity match parameter, etc. The number of parameters used by the scoring function may be determined based on the availability of parameters, quality of available parameters, and/or any other suitable selection criteria. The scoring function can be generically represented as:

$$score = {c}_{1} * {P}_{1} + {c}_{2} * {P}_{2} + ⋯ + {c}_{n} * {P}_{n}$$

$$score = {\sum }_{i = 1}^{n} {c}_{i} * {P}_{i}$$

where cᵢ is the coefficient for the i^{th} parameter, P, is a numerical representation of the i^{th} parameter, and n is the total number of parameters used to calculate the score.

In some embodiments, the scoring function 158 may be implemented directly by a trained ranking model 160. The trained ranking model 158 may be implemented by one or more systems, such as the item retrieval system 26. In some embodiments, the search process executed at step 104 and the trained ranking model 158 may be implemented by the same system and/or by different systems. In other embodiments, the set of candidate items may be ranked using a set of coefficients calculated by a trained ranking model 158 without being provided to the trained ranking model 160 directly.

As discussed below, the coefficients used by the scoring function 158 are simultaneously generated during training of the trained ranking model 160. For example, in some embodiments, the trained ranking model 160 is trained using a set of training data combining relevance data and engagement data for items in the pool of items 156. By training the trained ranking model 158 using combined relevance data and engagement data, coefficients implemented by the trained ranking model 158 are simultaneously selected (e.g., tuned) to balance the ranked search results based on relevance and engagement. For example, in some embodiments, the coefficients of the scoring function 158 are configured to balance relevance of the items in the set of candidate items 154 based on the search query with engagement of each item in the set of candidate items 154.

In some embodiments, the trained ranking model 158 implements a balance value during training to simultaneously select the coefficients of the scoring function to reflect a selected balance between relevance and engagement. For example, in some embodiments, a balance score may be based on a relevance score and an engagement score for items in the pool of items:

balance=relevance—score^{(1-w)}*engagement_score^{w}

where w is a weighting value between 0 and 1 that is selected to weight relevance and engagement to a greater or lesser degree. For example, using the above equation, a weighting value of 1 weights the balance of the trained ranking model 158 entirely to engagement of the items while a weighting value of 0 weights the balance of the trained ranking model 158 to relevance of the items. It will be appreciated that any suitable weighting value may be selected based on desired balance between the relevance and engagement of items in the pool of items 156.

In some embodiments, one or more metrics may be used to determine the weighting value w. For example, in some embodiments, offline metrics (i.e., non-real time metrics calculated from historical interaction data) may be used to determine a “relevance lift” and an “engagement lift.” The relevance lift and engagement lift are functions representing the change in a relevant metric, i.e., add-to-cart, purchase, etc., for items based on changes in the weighting of the relevance or engagement parameters. In some embodiments, the weighting factor w may be selected to be a value for which one of relevance or engagement is highly valued with a minimal reduction in value for the other one of relevance or engagement. It will be appreciated that any suitable method may be used for selecting the weighting factor w.

At step 108, a set of ranked items 162 is selected based on the scoring function 158. The set of ranked items 162 includes items ranked from, for example, highest to lowest, based on the scoring calculation performed at step 106. In some embodiments, the set of ranked items 162 includes all items in the set of candidate items 154 reordered based on the score ranking. In other embodiments, the set of ranked items 162 includes only a subset of the items in the set of candidate items 154. For example, where the set of candidate items 154 includes M items and the set of ranked items 162 includes N items, with M>N, the set of ranked items 162 includes the N items having the highest score (e.g., ranked highest) based on the scoring calculation performed at step 106.

At step 110, the set of ranked items 162 is provided to additional systems and/or processes of a search backend. The additional systems and/or processes are configured to select a subset of the set of ranked items 160 for presentation to a user in response to the user's search query. Any suitable additional selection processes and/or criteria may be applied to the set of ranked items 162 to selected items for presentation to a user. At step 112, a set of search results are provided to the user based on the set of ranked items 162 and the additional processing performed at step 110.

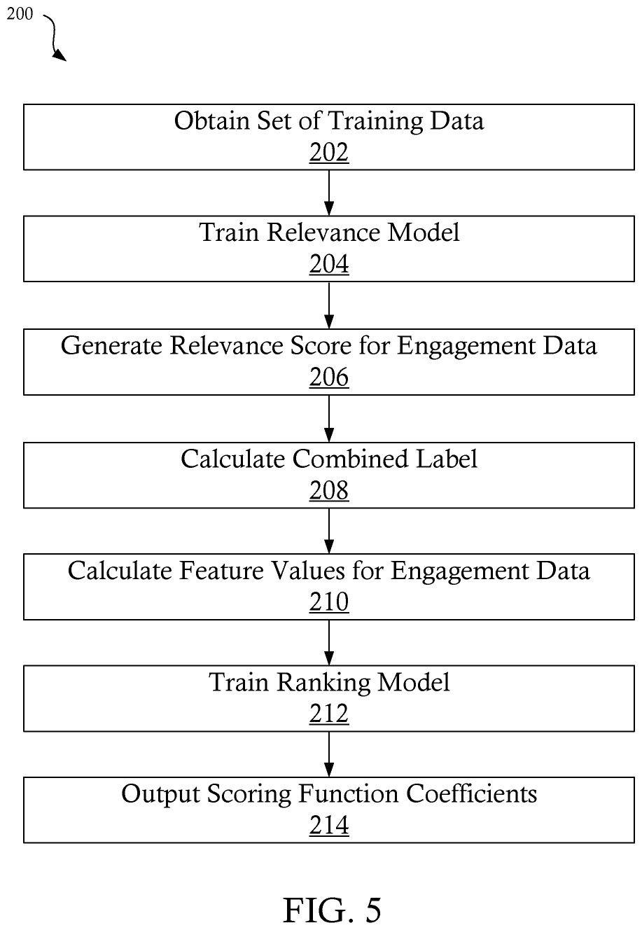

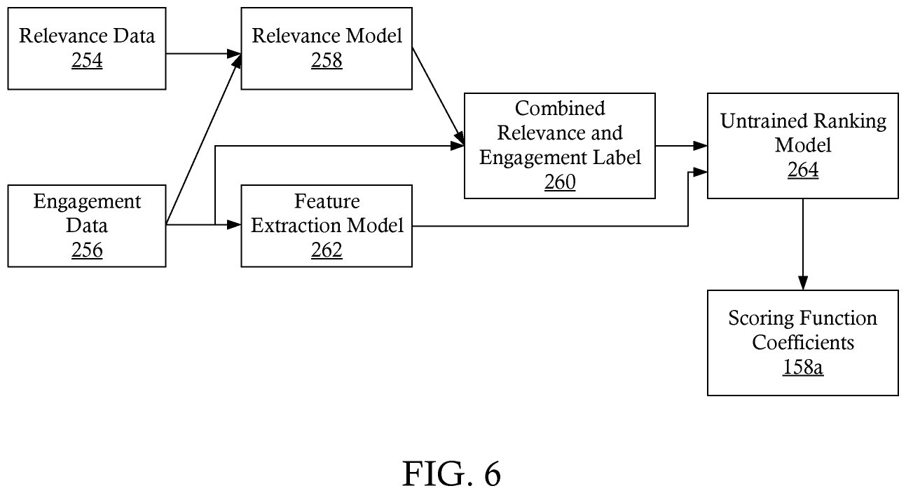

FIG. 5 is a flowchart 200 illustrating a method of training a model to generate a scoring function including a plurality of simultaneously determined coefficients, in accordance with some embodiments. FIG. 6 is a process flow 250 illustrating various steps of the method of training a model to generate a scoring function including a plurality of simultaneously determined coefficients illustrated in FIG. 5, in accordance with some embodiments.

At step 202, a set of training data 252 is provided to a system configured to train an untrained ranking model. The system may include any suitable systems, such as, for example, the model training system 28 discussed above. The set of training data 252 includes relevance data 254 and engagement data 256 for a set of items.

Relevance data 254 and/or engagement data 256 may be based on historical interaction data for a network environment, such as an e-commerce environment. In some embodiments, relevance data 254 may include labeled data identifying correspondence between a target string (e.g., search query) and one or more items. Labelled relevance data 254 may be generated manually and/or may be generated by one or more trained models configured to label relevance data 254. In some embodiments, engagement data 256 is generated from historical data, such as search logs. For example, in some embodiments, engagement data 256 is based on historic target queries (e.g., search strings) and interaction data (e.g., items viewed, added-to-cart, purchased, etc.) based on the target queries. Although specific embodiments are discussed herein, it will be appreciated that any suitable relevance data and/or engagement data may be used to train a trained ranking model.

At step 204, a relevance model 258 is trained using only the relevance data 254. The relevance model 258 is configured (i.e., trained), based on the labeled relevance data 254, to receive a target string and item pair and identify whether the item is relevant to the target string. In some embodiments, the relevance model 258 is configured to generate a probability that the item is relevant to the target string. The probability value may be represented as a value between 0 and 1, although it will be appreciated that other suitable numerical representations may be used.

At step 206, the engagement data 256 is provided to the trained relevance model 258 to generate a relevance score for each data pair (e.g., target string and item) in the engagement data 256. The items and/or target queries included in the engagement data 256 may be partially, fully, and/or non-overlapping with the items and/or target queries including in the relevance data 254. In some embodiments, overlapping data pairs may be used to validate the trained relevance model 258 prior to calculating relevance scores for non-overlapping data pairs.

At step 208, a combined relevance and engagement label 260 is calculated for each data pair in the engagement data 256. The combined relevance and engagement value may be generated by combining the relevance score of each data pair in the engagement data 256 with an engagement score provided for each data pair in the engagement data 256. Although embodiments are discussed herein including a provided engagement score, it will be appreciated that one or more models may be implemented to determine an engagement score from the engagement data 256 prior to combining the engagement score with the calculated relevance score.

In some embodiments, the relevance score and engagement score are combined based on a weighting factor w:

combined_label=relevance_score^{(1-w)}*engagement_score^{w}

where w is a value between 0 and 1. It will be appreciated that the weighting factor may be selected to weight the relevance score or the engagement score to a greater or lesser degree. For example, a value less than 0.5 weights the relevance score higher, while a value greater than 0.5 weights the engagement score higher. A value of 0.5 weights the relevance score and engagement score equally. It will be appreciated that any suitable weighting value may be used to combine the relevance score and engagement score

At step 210, one or more features values are calculated for each feature of the items included in the engagement data 256. For example, in some embodiments, the engagement data 256 is provided to a feature extraction model 262 that is configured to generate a feature value for each feature associated with an item in the engagement data 256. The extracted feature values correspond to the parameters used in the scoring function to score candidate items when performing retrieval, as discussed above with respect to FIGS. 3-4. The extracted feature values may include, but are not limited to, a text score feature, an item popularity feature, a product type match feature, a brand match feature, size match feature, a color match feature, a quantity match feature, etc.

At step 212, the extracted feature values and the combined relevance and engagement label 260 are provided to an untrained ranking model 264. An iterative training process is applied to the untrained ranking model 264 to determine coefficient values of a scoring function for each of the corresponding extracted feature values. For example, where the target scoring function includes a set of cₙ coefficients, the training process determines values for each of the coefficients based on a set of n extracted feature values. In some embodiments, the training algorithm includes a ListNet model, although it will be appreciate that any suitable model may be used, such as any suitable list-wise loss model, a linear regression model, RankNet model, etc.

The combined relevance and engagement label is configured to optimize the trained coefficients based on the weighting factor w previously applied. For example, where the weighting factor w is selected to weight relevance data greater than engagement data, the trained coefficients similarly reflect a higher weighting of relevance as compared to engagement. Similarly, where the weighting factor w is selected to weight engagement data greater than relevance data, the trained coefficients similarly reflect a higher weighting of engagement as compared to relevance. It will be appreciated that any suitable weighting factor w may be selected to provide any desired weighting of relevance and engagement in the ranked results generated by a trained ranking model.

At step 214, a scoring function 158s (i.e., coefficients of a scoring function) are provided for use in an item retrieval process, as discussed above in greater detail with respect to FIGS. 3-4. In some embodiments, a trained ranking model is provided directly to an item retrieval system 26 and/or a network repository for deployment. In other embodiments, only the calculated coefficients are provided for implementation in a scoring function, as discussed in greater detail with respect to FIGS. 3-4 above. It will be appreciated that the scoring function, the coefficients of the scoring function, and/or the trained ranking model 158a may be deployed in any suitable form configured to implement the scoring function in an item retrieval process.

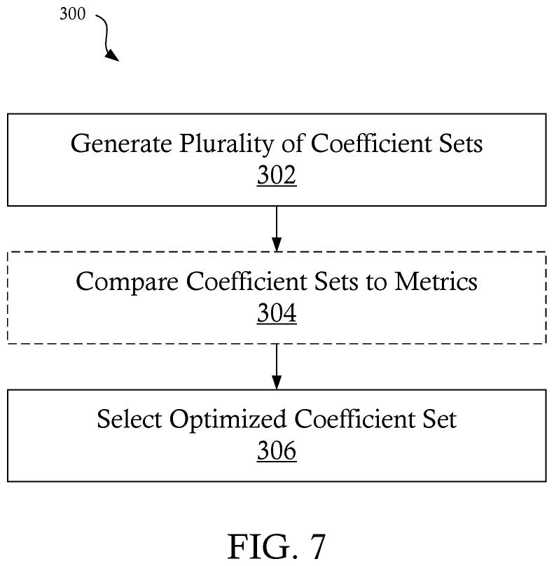

FIG. 7 illustrates a method of selecting a set of coefficients having an optimized weighting value w, in accordance with some embodiments. At step 302, a plurality of coefficient sets are generated according to the method of training a model to generate a scoring function including a plurality of simultaneously determined coefficients discussed above with respect to FIGS. 5-6. Each set of coefficients in plurality of coefficients is generated using a different weighting value w. For example, in some embodiments, a plurality of coefficients may be generated for weighting values between 0.3-0.5 in increments of 0.025 (e.g., 0.3, 0.325, 0.35, 0.375, etc.). Although specific embodiments are discussed herein, it will be appreciated that a plurality of coefficients may include coefficients generated for any value of w and at any increment (including random increments).

At step 304, each set of coefficients in the plurality of coefficients is compared based on a set of test data. The set of test data may include, for example, one or more target queries and one or more target items. Each of the target queries and/or target items may be provided to a plurality of scoring functions each configured using a different set of coefficients in the plurality of coefficients. A ranked output of each scoring function may be compared to select a set of optimal coefficients. Comparisons of ranked outputs may be based on, for example, a comparison of calculated metrics corresponding to a relevance lift, engagement lift, and/or other predetermined metric. The metric may be calculated based on historical interaction data and/or output of the set of trained ranking models.

At step 306, a set of optimized coefficients is selected based on the comparison of calculated metrics. For example, in some embodiments, the trained set of coefficients having one or more metrics performing at a desired value is selected from the plurality of coefficients. The set of optimal coefficients may be selected based on a single metric and/or a set of metrics. For example, in some embodiments, two or more calculated metrics may be combined based on one or more weighting factors to generate a final metric score used to rank and select a set of optimal coefficients from the plurality of coefficients. It will be appreciated that the set of optimal coefficients may be selected based on any desired criteria.

The disclosed systems and methods provide improvements over the current systems and methods used in the art. In one example, the use of the disclosed systems and methods has been shown to improve the normalized discounted cumulative gain (NDCG) for items in an e-commerce environment. NDCG is a commonly used ranking metric for showing the quality of ranked search results. As one example, application of the disclosed systems and methods provided an improvement of NDCG rank 5 (e.g., NDCG@5) and an improvement of NDCG rank 10 (e.g., NDCG@10). Although specific embodiments are discussed herein, it will be appreciated that the various systems and methods may be used to improve search results according to any specific metrics based on selection of item features and/or selection of the weighting factor w.

Although the subject matter has been described in terms of various embodiments, the claims should be construed broadly, to include other variants and embodiments, which may be made by those skilled in the art.

What is claimed is:

1. A system, comprising:
a non-transitory memory having instructions stored thereon and a processor configured to read the instructions to:
receive a target string;
obtain a set of candidate items from a pool of items based on the target string;
rank the set of candidate items based on a scoring function, wherein the scoring function includes a plurality of simultaneously determined coefficients, wherein the plurality of simultaneously determined coefficients are generated by a trained ranking model; and
output a set of N items selected from the set of candidate items based on the ranking.

2. The system of claim 1, wherein the trained ranking model is trained using a data set comprising relevance data and engagement data.

3. The system of claim 2, wherein the trained ranking model is trained using a set of combined relevance and engagement labels.

4. The system of claim 3, wherein each combined relevance and engagement label in the set of combined relevance and engagement labels is determined according to:
combined_label=relevance_score^{(1-w)}*engagement_score^{w}
where relevance_score is a relevance value for each data set in the engagement data, engagement_score is an engagement value for each data set in the engagement data, and w is a weighting factor between 0 and 1.

5. The system of claim 2, wherein the trained ranking model is trained using a relevance score calculated for each data pair in the engagement data.

6. The system of claim 5, wherein the relevance score is generated by a trained relevance model.

7. The system of claim 6, wherein the trained relevance model is generated based on the relevance data.

8. The system of claim 1, wherein the scoring function is:
$$score = {\sum }_{i = 1}^{n} {c}_{i} * {P}_{i}$$
where Pᵢ is an i^{th} feature of a candidate item in the set of candidate items, cᵢ is a coefficient corresponding to the i^{th} feature selected from the plurality of simultaneously determined coefficients, and n is the total number of features for the candidate item.

9. A non-transitory computer readable medium having instructions stored thereon, wherein the instructions, when executed by a processor cause a device to perform operations comprising:
receiving a target string;
obtaining a set of candidate items based on the target string;
ranking the set of candidate items based on a scoring function, wherein the scoring function includes a plurality of simultaneously determined coefficients, wherein the plurality of simultaneously determined coefficients are generated by a trained ranking model, wherein the scoring function is:
$$score = {\sum }_{i = 1}^{n} {c}_{i} * {P}_{i}$$
where Pᵢ is an i^{th} feature of a candidate item in the set of candidate items, cᵢ is a coefficient corresponding to the i^{th} feature selected from the plurality of simultaneously determined coefficients, and n is the total number of features for the candidate item; and
outputting a set of N items selected from the set of candidate items based on the ranking.

10. The non-transitory computer readable medium of claim 9, wherein the trained ranking model is trained using a data set comprising relevance data and engagement data.

11. The non-transitory computer readable medium of claim 10, wherein the trained ranking model is trained using a set of combined relevance and engagement labels.

12. The non-transitory computer readable medium of claim 11, wherein each combined relevance and engagement label in the set of combined relevance and engagement labels is determined according to:
combined_label=relevance_score^{(1-w)}*engagement_score^{w}
where relevance score is a relevance value for each data set in the engagement data, engagement score is an engagement value for each data set in the engagement data, and w is a weighting factor between 0 and 1.

13. The non-transitory computer readable medium of claim 10, wherein the trained ranking model is trained using a relevance score calculated for each data pair in the engagement data.

14. The non-transitory computer readable medium of claim 13, wherein the relevance score is generated by a trained relevance model.

15. The non-transitory computer readable medium of claim 14, wherein the trained relevance model is generated based on the relevance data.

16. A method, comprising:
receiving a target string;
obtaining a set of candidate items based on the target string;
ranking the set of candidate items based on a scoring function, wherein the scoring function includes a plurality of simultaneously determined coefficients, wherein the plurality of simultaneously determined coefficients are generated by a trained ranking model trained using a set of combined relevance and engagement labels; and
outputting a set of N items selected from the set of candidate items based on the ranking.

17. The method of claim 16, wherein the set of combined relevance and engagement labels is generated from a data set comprising relevance data and engagement data.

18. The method of claim 17, wherein the trained ranking model is trained using a relevance score calculated for each data pair in the engagement data.

19. The method of claim 18, wherein the relevance score is generated by a trained relevance model.

20. The method of claim 16, wherein the scoring function is:
$$score = {\sum }_{i = 1}^{n} {c}_{i} * {P}_{i}$$
where Pᵢ is an i^{th} feature of a candidate item in the set of candidate items, cᵢ is a coefficient corresponding to the i^{th} feature selected from the plurality of simultaneously determined coefficients, and n is the total number of features for the candidate item.
